(19) United States
(12) Patent Application Publication
(10) Pub. No.: US 2024/0093049 A1
(43) Pub. Date: Mar. 21, 2024

(54) Ink Jet Composition, Ink Set, And Dyeing Method

(71) Applicant: SEIKO EPSON CORPORATION, Tokyo (JP)

(72) Inventor: Takayoshi KAGATA, Shiojiri (JP)

(21) Appl. No.: 18/457,688

(22) Filed: Aug. 29, 2023

(30) Foreign Application Priority Data
Aug. 31, 2022 (JP) 2022-138287

(51) Int. Cl. C09D 11/38; B41M 5/00; B41M 5/41; C09D 11/328; C09D 11/40

(52) U.S. Cl. CPC C09D 11/38; B41M 5/0047; B41M 5/41; C09D 11/328; C09D 11/40

(57) ABSTRACT

An ink jet composition is an ink jet composition including a compound represented by Formula (1), a dispersant, and water, in which the dispersant contains a compound containing a sulfonic acid group. Further, in Formula (1), R¹ represents a hydrogen atom or a cyano group.

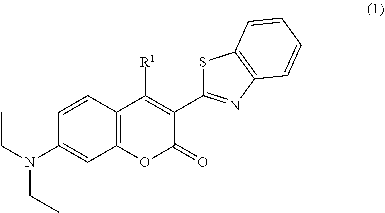

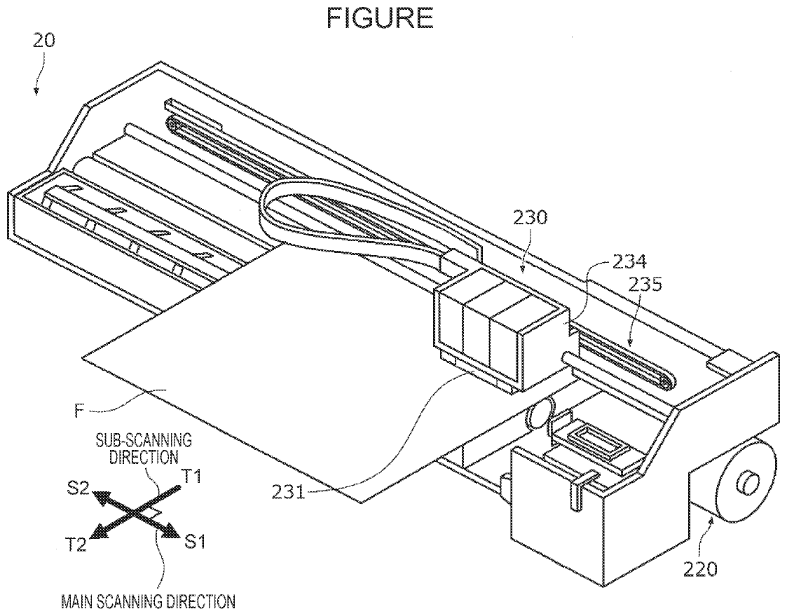

The present application is based on, and claims priority from JP Application Serial Number 2022-138287, filed Aug. 31, 2022, the disclosure of which is hereby incorporated by reference herein in its entirety.

### BACKGROUND

### 1. Technical Field

The present disclosure relates to an ink jet composition, an ink set, and a dyeing method.

### 2. Related Art

An ink jet recording method enables recording of a high-definition image with a relatively simple device, and thus rapid development has been made in various fields. Under such circumstances, various examinations on the color reproducibility and the reproduction range of a fluorescent color ink composition have been conducted. For example, JP-A-2016-190936 discloses, for the purpose of providing a textile ink set or the like with an excellent balance between chroma saturation and color developability, an ink set that includes a yellow ink and a magenta ink respectively containing at least two kinds of dyes having sublimability selected from a dispersed dye, an oil-soluble dye, and a vat dye, in which one kind of dye contained in the yellow ink is C.I. Disperse Yellow 82, and one kind of dye contained in the magenta ink is C.I. Vat Red 41.

However, it was found that when the ink composition contains C.I. Vat Red 41 as a magenta ink as described in JP-A-2016-190936, the pink color is strong, and thus the ink composition does not exhibit sufficient chroma saturation and color developability as a red color.

### SUMMARY

According to an aspect of the present disclosure, there is provided an ink jet composition including a compound represented by Formula (1), a dispersant, and water, in which the dispersant contains a compound containing a sulfonic acid group.

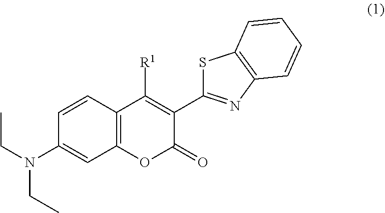

(In Formula (1), R¹ represents a hydrogen atom or a cyano group.)

According to another aspect of the present disclosure, there is provided an ink set including an ink jet composition containing a compound represented by Formula (1), a dispersant, and water, in which the dispersant contains a compound containing a sulfonic acid group, and at least one of a fluorescent yellow ink composition containing a fluorescent yellow dye or a fluorescent red ink composition containing a fluorescent red dye.

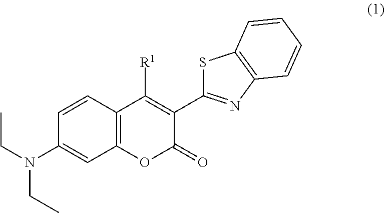

(In Formula (1), R¹ represents a hydrogen atom or a cyano group.)

According to still another aspect of the present disclosure, there is provided a dyeing method including an adhesion step of making the ink jet composition described above adhere to a recording surface of an intermediate transfer medium using an ink jet recording device, and a thermal transfer step of performing thermal transfer by making the recording surface and a medium to be dyed oppose each other.

### BRIEF DESCRIPTION OF THE DRAWING

FIGURE is a view showing an example of a recording device used for a dyeing method according to the present embodiment.

### DESCRIPTION OF EMBODIMENTS

Hereinafter, embodiments of the present disclosure (hereinafter, referred to as “present embodiment”) will be described in detail with reference to the accompanying drawing, but the present disclosure is not limited thereto, and various modifications can be made within a range not departing from the scope of the present disclosure. Further, in the accompanying drawing, the same elements are denoted by the same reference numerals, and overlapping descriptions will not be repeated. Further, the positional relationships in the vertical and horizontal directions are based on the positional relationships shown in the drawing unless otherwise specified. Further, the dimensional ratios in the drawing are not limited to the ratios shown in the drawing.

### 1. Ink Jet Composition

An ink jet composition according to the present embodiment (hereinafter, also simply referred to as “composition”) is a composition that contains a compound represented by Formula (1), a dispersant, and water, in which the dispersant contains a compound containing a sulfonic acid group. Further, in Formula (1), R¹ represents a hydrogen atom or a cyano group.

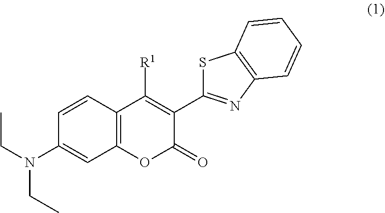

As described above, in the related art, C.I. Vat Red 41 has been known as a coloring material used as a fluorescent color. However, according to the examination conducted by the present inventors, most of the fluorescent coloring materials that have been known in the related art are strongly pinkish and do not exhibit sufficient chroma saturation or color developability as a red color.

Meanwhile, an ink jet composition containing the specific compound represented by Formula (1) as a coloring material is expected to exhibit a red color with high chroma saturation, but it has been known that the dispersion state of the compound represented by Formula (1) is difficult to stabilize as an ink jet composition. Here, the present inventors found that the storage stability of the ink jet composition containing the compound represented by Formula (1) as a color material is improved by using a dispersant that contains a compound containing a sulfonic acid group, and thus an ink jet composition with high chroma saturation of a red color and excellent color developability of fluorescence can be prepared. Hereinafter, each component of the ink jet composition will be described in detail.

### 1.1 Compound Represented by Formula (1)

The composition according to the present embodiment contains a compound represented by Formula (1) as a coloring material, and R¹ in the formula represents a hydrogen atom or a cyano group. In this manner, the red color in a recorded material is likely to have high chroma saturation, and the color developability, the color reproducibility, and the fluorescent color reproducibility are excellent. From the viewpoint that the color reproducibility and the fluorescent color reproducibility are further excellent, it is preferable that the compound contain a cyano group as R¹. Further, the compound represented by Formula (1) may be used alone or in combination of two or more kinds thereof.

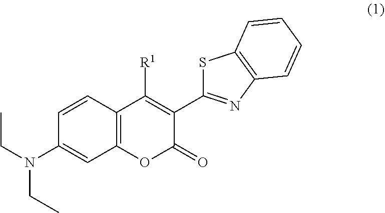

The content of the compound represented by Formula (1) is preferably 2% by mass or greater and 30% by mass or less with respect to the total amount of the composition. When the content of the compound represented by Formula (1) is in the above-described range, the composition has excellent storage stability, and the color developability, the color reproducibility, and the fluorescent color reproducibility of a dyed material to be obtained are likely to be excellent. From the same viewpoint as described above, the content of the compound represented by Formula (1) is more preferably 3% by mass or greater and 25% by mass or greater, still more preferably 4% by mass or greater and 20% by mass or less, and even still more preferably 4.5% by mass or greater and 15% by mass or less with respect to the total amount of the composition.

The composition according to the present embodiment may further contain a coloring material exhibiting a red color in addition to the compound represented by Formula (1). When the composition contains a coloring material exhibiting a red color in addition to the compound represented by Formula (1), the color developability, the color reproducibility, and/or the fluorescent color reproducibility of a dyed material is likely to be further excellent. From such a viewpoint, it is preferable that the composition contain at least one of Disperse Red 60 or Disperse Red 364 as a coloring material exhibiting a red color in addition to the compound represented by Formula (1).

### 1.2 Dispersant

The composition according to the present embodiment contains a dispersant, and as the dispersant, the composition contains a compound containing at least a sulfonic acid group. When the composition contains a compound containing a sulfonic acid group as the dispersant, the dispersion stability of the compound represented by Formula (1) is improved, and the storage stability, the jetting stability, and the like are further improved. Other dispersants are not particularly limited, and examples thereof include a nonionic dispersant and a polymer dispersant. Further, the dispersant may be used alone or in combination of two or more kinds thereof.

### 1.2.1 Compound Containing Sulfonic Acid Group

The compound containing a sulfonic acid group (hereinafter, also simply referred to as “sulfonic acid compound”) is one of the anionic dispersants. A formalin condensate of aromatic sulfonic acid is preferable as such a sulfonic acid compound. When a formalin condensate of aromatic sulfonic acid is used, the dispersion stability of the compound represented by Formula (1) in the composition is improved, and the storage stability, the jetting stability, and the like are likely to be further improved.

Examples of “aromatic sulfonic acid” in the formalin condensate of aromatic sulfonic acid include naphthalene sulfonic acid, creosote oil sulfonic acid, cresol sulfonic acid, phenol sulfonic acid, β-naphthol sulfonic acid, alkyl naphthalene sulfonic acid such as methyl naphthalene sulfonic acid or butyl naphthalene sulfonic acid, a mixture of β-naphthalene sulfonic acid and β-naphthol sulfonic acid, a mixture of cresol sulfonic acid and 2-naphthol-6-sulfonic acid, and lignin sulfonic acid. From the viewpoint of further improving the storage stability and the jetting stability of the composition, it is preferable to use naphthalene sulfonic acid as aromatic sulfonic acid. Further, from the same viewpoint as described above, it is more preferable to use a formalin condensate of sodium naphthalene sulfonate as the compound containing a sulfonic acid group of the present embodiment.

The content of the sulfonic acid compound is preferably 1% by mass or greater and 30% by mass or less with respect to the total amount of the composition. When the content of the sulfonic acid compound is in the above-described range, the storage stability and the jetting stability of the composition are likely to be further improved. From the same viewpoint as described above, the content of the sulfonic acid compound is more preferably 2% by mass or greater and 25% by mass or less, still more preferably 3% by mass or greater and 20% by mass or less, and even still more preferably 4% by mass or greater and 15% by mass or less.

### 1.2.2 Other Dispersants

The nonionic dispersant is not particularly limited, and examples thereof include an ethylene oxide adduct of phytosterol and an ethylene oxide adduct of cholestanol.

Further, the polymer dispersant is not particularly limited, and examples thereof include polyacrylic acid partial alkyl ester, polyalkylene polyamine, a polyacrylate, a styrene-acrylic acid copolymer, and a vinyl naphthalene-maleic acid copolymer.

The content of other dispersants is preferably 1% by mass or greater and 30% by mass or less with respect to the total amount of the composition. When the content of the other dispersants is in the above-described range, the storage stability and the jetting stability of the composition are likely to be further improved. From the same viewpoint as described above, the content of the other dispersants is more preferably 2% by mass or greater and 25% by mass or less, still more preferably 3% by mass or greater and 20% by mass or less, and even still more preferably 4% by mass or greater and 15% by mass or less.

### 1.3 Organic Solvent

The composition may contain an organic solvent. From the viewpoints of the storage stability and the jetting stability of the composition, it is preferable that the composition contain an organic solvent. Further, the organic solvent may be used alone or in combination of two or more kinds thereof.

The organic solvent is not particularly limited, and examples thereof include glycols such as glycerin, ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol, glycol ethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, methyl triglycol (triethylene glycol monomethyl ether), butyl triglycol (triethylene glycol monobutyl ether), and butyl diglycol (diethylene glycol monobutyl ether), nitrogen-containing compounds such as 2-pyrrolidone, N-methyl-2-pyrrolidone, and N-ethyl-2-pyrrolidone, alcohols such as methanol, ethanol, n-propyl alcohol, iso-propyl alcohol, n-butanol, 2-butanol, tert-butanol, iso-butanol, n-pentanol, 2-pentanol, 3-pentanol, and tert-pentanol, and ethers other than glycol ethers such as 3-methyl-3-hydroxymethyl oxetane, 3-ethyl-3-hydroxymethyl oxetane, 2-hydroxymethyl oxetane, solketal, isosorbide dimethyl ether (DMIS), dihydrolevoglucosenone, isosorbide, glycerol formal, and 1,4-dioxane-2,3-diol.

Among the compounds exemplified as the organic solvent, the organic solvent having a relatively high boiling point, such as glycerin, propylene glycol, or diethylene glycol, functions excellently as a moisturizing agent. In the present embodiment, from the viewpoint of improving the jetting stability of the composition, it is preferable that the composition contain a moisturizing agent. From the same viewpoint as described above, the composition contains more preferably a glycol compound as a moisturizing agent, still more preferably at least one of glycerin or propylene glycol, and even still more preferably glycerin and propylene glycol.

Among the compounds exemplified as the organic solvent, alkanediol, glycol ethers, or the like functions excellently as a penetration solvent with respect to a medium to be dyed. In the present embodiment, from the viewpoints of the wettability of the compound with respect to a medium and the color developability, the color reproducibility, the fluorescent color reproducibility, and the like of a dyed material, it is preferable that the composition contain a penetration solvent. From the same viewpoint as described above, the composition contains more preferably glycol ethers and still more preferably methyl triglycol.

The total content of the compounds exemplified as the organic solvent is not particularly limited, but is, for example, 4% by mass or greater and 60% by mass or less, preferably 5% by mass or greater and 40% by mass or less, and more preferably 10% by mass or greater and 30% by mass or less with respect to the total amount of the composition.

### 1.4. Surfactant

The composition according to the present embodiment may contain a surfactant. The surfactant is not particularly limited, and examples thereof include a silicone-based surfactant, an acetylene glycol-based surfactant, and a fluorine-based surfactant. From the viewpoint of improving the storage stability and the jetting stability of the composition and improving the color developability, the color reproducibility, and the fluorescent color reproducibility of a dyed material, it is preferable that a silicone-based surfactant be used as a surfactant. Further, the surfactant may be used alone or in combination of two or more kinds thereof.

The silicone-based surfactant is not particularly limited, and examples thereof include a polysiloxane-based compound and polyether-modified organosiloxane.

A commercially available product of the silicone-based surfactant is not particularly limited, and specific examples thereof include SAG503A (trade name, manufactured by Nissin Chemical Co., Ltd.), BYK-306, BYK-307, BYK-333, BYK-341, BYK-345, BYK-346, BYK-347, BYK-348, and BYK-349 (all trade names, manufactured by BYK-Chemie GmbH), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.). Among these, from the viewpoint of more reliably exhibiting the effects of the present disclosure, it is preferable that the composition contain BYK-348.

Examples of the acetylene glycol-based surfactant is not particularly limited, and examples thereof include an alkylene oxide adduct of 2,4,7,9-tetramethyl-5-decyne-4,7-diol and 2,4,7,9-tetramethyl-5-decyne-4,7-diol, and an alkylene oxide adduct of 2,4-dimethyl-5-decyne-4-ol and 2,4-dimethyl-5-decyne-4-ol.

The fluorine-based surfactant is not particularly limited, and examples thereof include a perfluoroalkyl sulfonate, a perfluoroalkyl carboxylate, perfluoroalkyl phosphoric acid ester, a perfluoroalkyl ethylene oxide adduct, perfluoroalkyl betaine, and a perfluoroalkylamine oxide compound.

A commercially available product of the fluorine-based surfactant is not particularly limited, and examples thereof include S-144 and S-145 (both trade names, manufactured by AGC Inc.), FC-170C, FC-430, and FLUORAD FC4430 (all product names, manufactured by Sumitomo 3M Ltd.), FSO, FSO-100, FSN, FSN-100, and FS-300 (all product names, manufactured by Dupont), and FT-250 and 251 (both product names, manufactured by Neos Co., Ltd.).

The content of the surfactant is not particularly limited, and may be, for example, 0% by mass or greater and 10% by mass or less with respect to the total amount of the composition. From the viewpoint of more reliably exhibiting the effects of the present disclosure, the content thereof is preferably 0.1% by mass or greater and 5% by mass or less, more preferably 0.2% by mass or greater and 3% by mass or less, and still more preferably 0.3% by mass or greater and 2% by mass or less.

### 1.5. Water

The composition according to the present embodiment is an aqueous composition containing water. As water, pure water such as ion exchange water, ultrafiltration water, reverse osmosis water, or distilled water, or water obtained by removing ionic impurities as much as possible such as ultrapure water is preferable.

From the viewpoint of further improving the color developability, the color reproducibility, and/or the fluorescent color reproducibility of a dyed material, the content of water is preferably 60% by mass or greater and 98% by mass or less with respect to the total amount of the composition. From the same viewpoint as described above, the content of water is more preferably 60% by mass or greater and 95% by mass or less, still more preferably 65% by mass or greater and 90% by mass or less, even still more preferably 65% by mass or greater and 85% by mass or less, and particularly preferably 65% by mass or greater and 80% by mass or less.

### 1.6 Other Additives

The composition according to the present embodiment may further contain a fungicide, a preservative, an antioxidant, an ultraviolet absorbing agent, a chelating agent, an oxygen absorbing agent, a pH adjusting agent, or a dissolution assistant, and various other additives that can be used in typical compositions as necessary. Further, various additives may be used alone or in combination of two or more kinds thereof.

From the viewpoint of more reliably exhibiting the effects of the present disclosure, the content of the other additives is preferably 10% by mass or less, more preferably 8% by mass or less, still more preferably 5% by mass or less, even still more preferably 2% by mass or less, and particularly preferably 0% by mass or less with respect to the total amount of the composition.

### 1.7. Method of Producing Ink Jet Composition

A method of producing the composition according to the present embodiment is not particularly limited, and examples thereof include a method of mixing the compound represented by Formula (1), a dispersant, water, the compound containing at least a sulfonic acid group as a dispersant, and other components as necessary. Further, the order of mixing the components is not particularly limited, and for example, the compound represented by Formula (1), the compound containing a sulfonic acid group, and water are mixed to obtain a mixture, and an organic solvent component and a surfactant may be added to the mixture as necessary.

### 1.8. Applications

The composition according to the present embodiment can be used as an ink jet ink composition (hereinafter, also simply referred to as “ink” or “ink composition”) exhibiting a red color or may be used as an ink composition for sublimation transfer. In this manner, the color developability, the color reproducibility, and the fluorescent color reproducibility of a dyed material to be obtained are improved. Further, the composition according to the present embodiment may be used as a dispersion liquid. The dispersion liquid can be used as a raw material of an ink composition for sublimation transfer, which exhibits a red color.

### 2. Ink Set

An ink set according to the present embodiment includes the above-described composition and at least one of a fluorescent yellow ink composition containing a fluorescent yellow dye or a fluorescent red ink composition containing a fluorescent red dye. When the ink set includes the above-described composition and at least one of a fluorescent yellow ink composition containing a fluorescent yellow dye or a fluorescent red ink composition containing a fluorescent red dye, the color developability, the color reproducibility, and the fluorescent color reproducibility of a dyed material are improved.

Further, in the present specification, the ink set denotes two or more kinds of ink compositions used for recording an image as a set, and the ink compositions of the ink set may be contained in ink composition containers separately for each ink or in an integrated ink composition container.

It is preferable that the ink set according to the present embodiment further include a cyan ink composition containing a cyan dye, a magenta ink composition containing a magenta dye, a yellow ink composition containing a yellow dye, and a black ink composition containing a black dye. When the ink set further includes the above-described ink compositions, the color reproducibility and/or the fluorescent color reproducibility of a dyed material is further improved.

Further, from the viewpoint of exhibiting the same effects as described above, it is preferable that the ink set according to the present embodiment further include a fluorescent blue ink composition containing a fluorescent blue dye.

Further, the ink set according to the present embodiment may further include a cyan ink composition, a magenta ink composition, a yellow ink composition, a black ink composition, and a fluorescent blue ink composition.

From the viewpoint of more reliably exhibiting the effects of the present disclosure, it is preferable that the ink set according to the present embodiment be formed by combining ink compositions containing a sublimation dye. The sublimation dye is not particularly limited, and examples thereof include Disperse Yellow 3, 7, 8, 23, 39, 51, 54, 60, 71, 86, and 232, Disperse Orange 1, 1:1, 5, 20, 25, 33, 56, and 76, Disperse Brown 2, Disperse Red 11, 50, 53, 55, 55:1, 59, 60, 65, 70, 75, 93, 146, 158, 190, 190:1, 207, 239, 240, and 364, Disperse Blue 14, 19, 26, 26:1, 35, 55, 56, 58, 64, 64:1, 72, 72:1, 81, 81:1, 91, 95, 108, 131, 141, 145, and 359, and Disperse Violet 8, 17, 23, 27, 28, 29, 36, and 57.

Among these sublimation dyes, it is preferable that the ink compositions contain Disperse Red 60 as a magenta dye, Disperse Red 364 as a fluorescent pink dye, Disperse Yellow 82 as a fluorescent yellow dye, Disperse Blue 359 as a cyan dye, Disperse Yellow 54 as a yellow dye, and Disperse Blue 60 as a fluorescent blue dye. Further, it is preferable that Disperse Yellow 54, Disperse Orange 25, Disperse Blue 360, and Sumiplast Orange HRP be appropriately mixed and used as a black dye.

The effects of the present disclosure tend to be more reliably exhibited by using the ink compositions containing the sublimation dyes described above.

The composition of each ink composition in the ink set can be adjusted at the same mixing ratio as those for the compositions described above except for the adjustment of the black dye. Further, as the mixing ratio between the respective dyes in the black dye, the proportions disclosed in the example described below may be used.

### 3. Dyeing Method

A dyeing method according to the present embodiment includes an adhesion step of making the composition described above adhere to a recording surface of an intermediate transfer medium using an ink jet recording device and a thermal transfer step of thermally transferring an image by making the recording surface and a medium to be dyed oppose each other. The color developability, the color reproducibility, and the fluorescent color reproducibility of the dyed material are improved by using the above-described composition.

### 3.1. Adhesion Step

In the adhesion step, the above-described composition is made to adhere to a recording surface of an intermediate transfer medium using an ink jet recording device. A high-quality recorded material can be more easily obtained by using an ink jet method.

The ink jet recording device used in the adhesion step is not particularly limited, and any of a serial type recording device or a line type recording device can be used. FIGURE is a perspective view showing a serial type recording device as an example of the ink jet recording device. As shown in FIGURE, a serial type recording device 20 includes a transport unit 220 and a recording unit 230. The transport unit 220 transports a recording medium F which has been fed to the serial type recording device, to the recording unit 230 and discharges the recording medium after recording an image to the outside of the serial type recording device. Specifically, the transport unit 220 has a feeding roller and transports the fed recording medium F in a sub-scanning direction Ti.

Further, the recording unit 230 in the recording device includes a carriage 234 on which an ink jet head 231 having nozzles for jetting the ink composition to the recording medium F fed from the transport unit 220 is mounted, and a carriage moving mechanism 235 that moves the carriage 234 in a main scanning direction S1-S2 of the recording medium F. Here, the recording medium F may be a medium A before recording an image or an intermediate transfer medium. The dye adhering to the intermediate transfer medium may be sublimated and transferred to the medium A.

Further, the recording unit 230 in the recording device has nozzles for jetting the ink composition.

In a case of the serial type recording device, the recording device includes a head having a length less than the width of the recording medium as the ink jet head 231, the head moves, and an image is recorded in a plurality of passes (multipass). Further, in the serial type recording device, the head 231 is mounted on the carriage 234 that moves in a predetermined direction so that the ink composition is jetted onto the recording medium by moving the head along with the movement of the carriage. In this manner, adhesion of the ink composition is carried out in two or more passes (multipass). Further, the pass is also referred to as main scanning. Sub-scanning for transporting the recording medium is performed between the passes. In other words, the main scanning and the sub-scanning are alternately performed.

In the present embodiment, when the serial type recording device 20 shown in FIGURE is used as a device for dyeing the medium A with a dispersed dye, a colored ink composition containing a dispersed dye may be used. Further, when the serial type recording device 20 shown in FIGURE is used in the adhesion step of the ink composition, the ink composition may be used in place of a colored ink composition. In addition, the ink jet head 231 has nozzles for jetting the ink composition, and may perform a combination of dyeing and discharge dyeing with the same printer.

### 3.2. Thermal Transfer Step

In the thermal transfer step, the recording surface of the intermediate transfer medium and the medium to be dyed are made to oppose each other and heated so that an image recorded on the recording surface is thermally transferred to the medium to be dyed.

The heating temperature in the thermal transfer step is not particularly limited, and may be 160° C. or higher and 250° C. or lower or 180° C. or higher and 220° C. or lower. When the thermal transfer is performed at such a heating temperature, the dyed material tends to have more excellent color developability. Further, the heating time may be appropriately adjusted according to the heating temperature, but is, for example, preferably 30 seconds or longer and 120 seconds or shorter and more preferably 40 seconds or longer and 90 seconds or shorter. When the heating time is in the above-described ranges, since the transferability to the medium to be dyed is improved and bleeding is suppressed, the color developability is likely to be further improved.

In the thermal transfer step, the heating is performed preferably in a state where the recording surface of the intermediate transfer medium and the medium to be dyed are in close contact with each other and more preferably in a state where the recording surface thereof and the medium to be dyed are pressed. When the heating is performed while the recording surface thereof and the medium to be dyed are pressed, since the transferability to the medium to be dyed is improved and bleeding is suppressed, the color developability is likely to be excellent. For example, a heat press machine may be used when such a step is performed.

The medium to be dyed according to the present embodiment is not particularly limited as long as the medium is fabric that absorbs dye components. Examples of fibers constituting the fabric include natural fibers such as cotton, hemp, wool, and silk, synthetic fibers such as polyester, acryl, nylon, polypropylene, acetate, triacetate, polyamide, and polyurethane, biodegradable fibers such as polylactic acid, and mixed fibers thereof. From the viewpoint of more reliably exhibiting the effects of the present disclosure, such as the color developability, the color reproducibility, and the fluorescent color reproducibility, it is preferable to use a medium including at least one among polyester, acryl, nylon, and a medium having a surface provided with a polyester layer as the medium to be dyed.

### Examples

Hereinafter, the present disclosure will be described in more detail based on examples and comparative example. The present disclosure is not limited to the following examples.

### 1. Preparation of Dispersion Liquid

A coloring material, a dispersant, and pure water were mixed to have the composition as listed in Table 1, and the mixture was put into a High Shear Mixer (manufactured by Silverson) and stirred at 3000 rpm. A slurry obtained in this manner and glass beads having a diameter of 0.5 mm were put into a bead mill (product name, “LMZ015”, manufactured by Ashizawa Finetech Ltd.) and stirred and dispersed while being cooled, thereby obtaining a dispersion liquid. Further, the average particle diameter of the dye contained in the obtained dispersion liquid was approximately 130 nm. Further, the numerical value of each component shown in each example of the table denotes the content (% by mass) unless otherwise specified.

### 2. Preparation of Ink Composition

The dispersion liquid or a dispersion liquid containing other dispersed dyes and each component were put into a tank for a mixture to have the composition listed in Tables 2 and 3, mixed, stirred, and filtered through a membrane filter, thereby obtaining an ink jet composition of each example. The obtained ink jet composition was used as the ink composition. Further, the numerical value of each component shown in each example of the tables denotes the content (% by mass) thereof with respect to the total amount of the composition unless otherwise specified.

### 3. Preparation of Ink Set

Each ink set listed in Table 5 was obtained by selecting the combination of obtained inks as listed in Table 5.

The details of the abbreviations and the product components listed in Tables 1 to 5 are as follows.

### Coloring Material

Red 1 (compound represented by Formula (A))

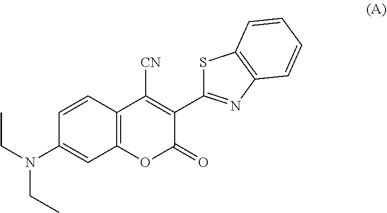 [SMILES: CCN(CC)c1ccc2c(C#N)c(-c3nc4ccccc4s3)c(=O)oc2c1]

Red 2 (compound represented by Formula (B))

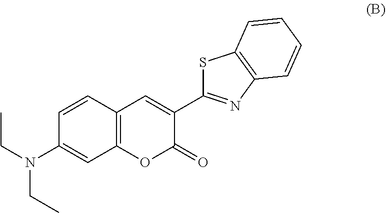 [SMILES: CCN(CC)c1ccc2cc(-c3nc4ccccc4s3)c(=O)oc2c1]

DR60 (C.I. Disperse Red 60)
DR364 (C.I. Disperse Red 364)
DY82 (C.I. Disperse Yellow 82)
DB359 (C.I. Disperse Blue 359)
DY54 (C.I. Disperse Yellow 54)
DO25 (C.I. Disperse Orange 54)
DB360 (C.I. Disperse Blue 360)
SO60 (Sumiplast Orange HRP)
DB60 (C.I. Disperse Blue 60)

### Dispersant

Formalin condensate of sodium naphthalene sulfonate (DEMOL NL, manufactured by Kao Corporation)
Polyoxyethylene sorbitan fatty acid ester (SORBON T-40, manufactured by Toho Chemical Industry Co., Ltd.)

### Organic Solvent

Propylene glycol
Glycerin
Methyl triglycol (triethylene glycol monomethyl ether) Surfactant
BYK348 (trade name, silicone-based surfactant, manufactured by BYK-Chemie GmbH)

### Abbreviation of Ink

R1 (ink 1 listed in Table 2)
R2 (ink 2 listed in Table 2)
M (ink 3 listed in Table 2)
FP (ink 4 listed in Table 2)
FY (ink 5 listed in Table 3)
C (ink 6 listed in Table 3)
Y (ink 7 listed in Table 3)
K (ink 8 listed in Table 3)
Tq (ink 9 listed in Table 9)

### 4. Evaluation Method

### 4.1. Storage Stability

A storage bottle capable of sealing the dispersion liquid which was the ink jet composition obtained above was charged with the dispersion liquid and allowed to stand at 70° C. for 1 week. Next, the storage bottle after the standing was taken out and sufficiently cooled to room temperature, and the viscosity of the dispersion liquid was measured using a vibration type viscometer in conformity with JIS Z 8809. Further, the measured viscosity was compared to the viscosity before the standing which was measured in the same manner as described above. The storage stability was evaluated based on the following evaluation criteria. The results are listed in Table 1.

### Evaluation Criteria

A: The absolute value of a change in viscosity was less than 5
B: The absolute value of a change in viscosity was 5 or greater and less than 10
C: The absolute value of a change in viscosity was 10 or greater and less than 15

### 4.2. Evaluation Using Colorimeter

### 4.2.1. Color Developability

Recording was performed with the ink obtained above on TRANSJET Classic (manufactured by Cham Paper) serving as an intermediate transfer medium using an ink jet printer (trade name, “SureColor SC-F7000”, manufactured by Seiko Epson Corporation) under conditions of a resolution of 1440×720 dpi and an adhesion amount of 21 g/m², to output a color chart.

Thereafter, a side of the intermediate transfer medium where the ink adhered was brought into close contact with fabric (polyester 100%, AMINA, manufactured by Toray Industries, Inc.) serving as a white recording medium, the media were heated using a heat press machine (TP-608M, manufactured by Horizon Inc.) under conditions of 200° C. for 60 seconds and subjected to sublimation transfer, thereby obtaining a dyed material dyed with each ink. The L* value, the a* value, the b* value, and the fluorescent brightening intensity of the obtained reference color chart image were measured using a colorimeter (trade name, “FD-7”, manufactured by Konica Minolta, Inc.). Here, the fluorescent brightening intensity is obtained by calculating B(D65) which is the brightness of the D65 light source and B(UVcut) which is the brightness of the D65 light source after cutting a wavelength of 410 nm or less of the D65 light source, both of which are measured with a colorimeter, according to the following equation.

Fluorescent brightening intensity ΔB=B(D65)−B(UVcut)

The color developability was evaluated based on the obtained L* value, the a* value, the b* value, and the fluorescent brightening intensity according to the following evaluation criteria. These results are listed in Table 4.

### Evaluation Criteria

O: The L* value was 50 or greater, the a* value was 77 or greater, the b* value was 10 or greater, and the fluorescent brightening intensity was 1.5 or greater
X: The L* value was less than 50, the a* value was less than 77, the b* value was less than 10, and the fluorescent brightening intensity was less than 1.5

### 4.2.2. Color Reproduction Range

A color chart was output in the same manner as in the method of evaluating the color developability except that each ink set obtained above was used, and the L* value, the a* value, and the b* value of each of the obtained reference color chart images were measured using the same colorimeter as described above. Further, the value of the volume of the L*a*b* color reproduction range (gamut value 1) was calculated based on the measured values, and the color reproduction range was evaluated according to the following evaluation criteria. The results are listed in Table 5.

### Evaluation Criteria

AA: The gamut value 1 was 450000 or greater
A: The gamut value 1 was 400000 or greater and less than 450000
B: The gamut value 1 was 350000 or greater and less than 400000
C: The gamut value 1 was 300000 or greater and less than 350000
D: The gamut value 1 was 250000 or greater and less than 300000

### 4.2.3. Fluorescent Color Reproduction Range

A color chart was output in the same manner as in the method of evaluating the color developability except that each ink set obtained above was used, and the L* value, the a* value, the b* value, and the fluorescent brightening intensity of each of the obtained reference color chart images were obtained by the same calculation method using the same colorimeter as described above. Further, the value of the volume of the L*a*b* color reproduction range (gamut value 2) of each ink set was calculated by plotting points where the obtained fluorescent brightening intensity was 0.6 or greater, and the fluorescent color reproduction range was evaluated according to the following evaluation criteria.

### Evaluation Criteria

AA: The gamut value 2 was 250000 or greater
A: The gamut value 2 was 200000 or greater and less than 250000
B: The gamut value 2 was 150000 or greater and less than 200000
C: The gamut value 2 was 100000 or greater and less than 150000
D: The gamut value 2 was 50000 or greater and less than 100000

TABLE 1

| | | Example | Example | Comparative | Comparative |
|---|---|---|---|---|---|
| | | A1 | A2 | Example A1 | Example A2 |
| Coloring | Red1 | 15 | | 15 | |
| material | Red2 | | 15 | | 15 |
| Dispersant | Formalin condensate | 15 | 15 | | |
| | of sodium | | | | |
| | naphthalene | | | | |
| | sulfonate | | | | |
| | Polyoxyethylene | | | 15 | 15 |
| | sorbitan fatty acid | | | | |
| | ester | | | | |

| | | | | |
|---|---|---|---|---|
| Storage stability | A | A | C | C |

TABLE 2

| | | Ink 1: R1 | Ink 2: R2 | Ink 3: M | Ink 4: Fp |
|---|---|---|---|---|---|
| Coloring | Red1 | 5.0% | | | |
| material | Red2 | | 5.0% | | |
| | DR60 | | | 5.0% | |
| | DR364 | | | | 5.0% |
| | DY82 | | | | |
| | DB359 | | | | |
| | DY54 | | | | |
| | DO25 | | | | |
| | DB360 | | | | |
| | SO60 | | | | |
| | DB60 | | | | |
| Dispersant | Formalin condensate of | 5.0% | 5.0% | 5.0% | 5.0% |
| | sodium naphthalene | | | | |
| | sulfonate | | | | |
| Organic | Propylene glycol | 5.0% | 5.0% | 5.0% | 5.0% |
| solvent | Glycerin | 10.0% | 10.0% | 10.0% | 10.0% |
| | Methyl triglycol | 5.0% | 5.0% | 5.0% | 5.0% |
| Surfactant | BYK348 | 0.5% | 0.5% | 0.5% | 0.5% |
| Water | Pure water | 69.5% | 69.5% | 69.5% | 69.5% |

| | | | | |
|---|---|---|---|---|
| Total | 100% | 100% | 100% | 100% |

TABLE 3

| | | Ink 5: | Ink 6: | Ink 7: | Ink 8: | Ink 9: |
|---|---|---|---|---|---|---|
| | | Fy | C | Y | K | Tq |
| Coloring | Red1 | | | | | |
| material | Red2 | | | | | |
| | DR60 | | | | | |
| | DR364 | | | | | |
| | DY82 | 5.0% | | | | |
| | DB359 | | 5.0% | | | |
| | DY54 | | | 5.0% | 0.5% | |
| | DO25 | | | | 1.0% | |
| | DB360 | | | | 2.0% | |
| | SO60 | | | | 1.0% | |
| | DB60 | | | | | 5.0% |
| Dispersant | Formalin condensate of | 5.0% | 5.0% | 5.0% | 4.5% | 5.0% |
| | sodium naphthalene | | | | | |
| | sulfonate | | | | | |
| Organic | Propylene glycol | 5.0% | 5.0% | 5.0% | 5.0% | 5.0% |
| solvent | Glycerin | 10.0% | 10.0% | 10.0% | 10.0% | 10.0% |
| | Methyl triglycol | 5.0% | 5.0% | 5.0% | 5.0% | 5.0% |
| Surfactant | BYK348 | 0.5% | 0.5% | 0.5% | 0.5% | 0.5% |
| Water | Pure water | 69.5% | 69.5% | 69.5% | 70.5% | 69.5% |

| | | | | | |
|---|---|---|---|---|---|
| Total | 100% | 100% | 100% | 100% | 100% |

TABLE 4

| | Example | Example | Comparative | Comparative |
|---|---|---|---|---|
| | B1 | B2 | Example B1 | Example B2 |
| Ink | R1 | R2 | M | Fp |
| L* | 60.59 | 66.52 | 45.66 | 57.06 |
| a* | 82.43 | 81.44 | 73.12 | 75.95 |
| b* | 17.55 | 12.92 | 26.5 | 5.79 |
| Fluorescent brightening intensity | 1.98 | 2.58 | 0.22 | 0.7 |
| Color developability | ∘ | ∘ | x | x |

TABLE 5

| | | Example C1 | Example C2 | Example C3 | Example C4 |
|---|---|---|---|---|---|
| Ink set | Combination | C, M, Y, K, Fy, | C, M, Y, K, Fy, | C, M, Y, K, Fy, | Fy, R1, Tq |
| | | Fp, R1, Tq | R1, Tq | R1 | |
| | Number of colors | 8 | 7 | 6 | 3 |
| Evaluation | Color reproduction | AA | A | B | B |
| | range | | | | |
| | Fluorescent color | AA | A | B | B |
| | reproduction range | | | | |

| | | Comparative | Comparative | Comparative |
|---|---|---|---|---|
| | | Example C1 | Example C2 | Example C3 |
| Ink set | Combination | C, M, Y, K, Fy, | C, M, Y, K, Fy, | Fy, Fp. Tq |
| | | Fp, Tq | Fp | |
| | Number of colors | 7 | 6 | 3 |
| Evaluation | Color reproduction | A | C | C |
| | range | | | |
| | Fluorescent color | B | B | C |
| | reproduction range | | | |

### 5. Evaluation Results

The ink jet compositions and the ink compositions used in each example, and the evaluation methods thereof are listed in Tables 1 to 5.

As listed in Table 1, it was found that the storage stability of the ink jet composition is improved when the ink jet composition contains the compound represented by Formula (1), a dispersant, and water, and the dispersant contains a compound containing a sulfonic acid group.

As listed in Tables 1 to 4, it was found that the color developability of the ink jet composition and the ink composition is improved when the ink jet composition contains the compound represented by Formula (1), a dispersant, and water, and the dispersant contains a compound containing a sulfonic acid group.

As listed in Tables 1 to 5, it was found that the ink set including an ink jet composition containing the compound represented by Formula (1), a dispersant, and water in which the dispersant contains a compound containing a sulfonic acid group, and at least one of a fluorescent yellow ink composition containing a fluorescent yellow dye or a fluorescent red ink composition containing a fluorescent red dye has an excellent color reproduction range and an excellent fluorescent color reproduction range.

What is claimed is:

1. An ink jet composition comprising:
a compound represented by Formula (1);
a dispersant; and
water,
wherein the dispersant contains a compound containing a sulfonic acid group, 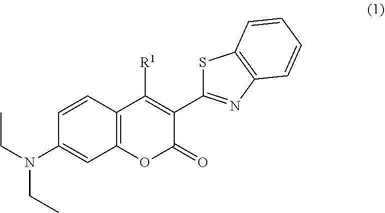
in Formula (1), R¹ represents a hydrogen atom or a cyano group.

2. The ink jet composition according to claim 1,
wherein a content of the compound represented by Formula (1) is 2% by mass or greater and 30% by mass or less with respect to a total amount of the ink jet composition.

3. The ink jet composition according to claim 1,
wherein a content of the water is 60% by mass or greater and 98% by mass or less with respect to a total amount of the ink jet composition.

4. The ink jet composition according to claim 1, further comprising:
at least one of Disperse Red 60 or Disperse Red 364.

5. The ink jet composition according to claim 1,
wherein the ink jet composition is an ink jet ink composition.

6. The ink jet composition according to claim 1, further comprising:
an organic solvent.

7. An ink set comprising:
an ink jet composition containing a compound represented by Formula (1), a dispersant, and water, in which the dispersant contains a compound containing a sulfonic acid group; and
at least one of a fluorescent yellow ink composition containing a fluorescent yellow dye or a fluorescent red ink composition containing a fluorescent red dye, 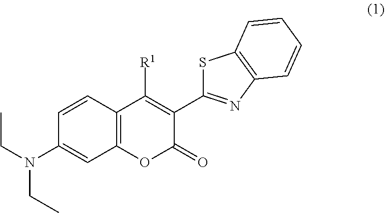
in Formula (1), R¹ represents a hydrogen atom or a cyano group.

8. The ink set according to claim 7, further comprising:
a cyan ink composition containing a cyan dye;
a magenta ink composition containing a magenta dye;
a yellow ink composition containing a yellow dye; and
a black ink composition containing a black dye.

9. The ink set according to claim 7, further comprising:
a fluorescent blue ink composition containing a fluorescent blue dye.

10. A dyeing method comprising:
an adhesion step of making the ink jet composition according to claim 1 adhere to a recording surface of an intermediate transfer medium using an ink jet recording device; and
a thermal transfer step of performing thermal transfer by making the recording surface and a medium to be dyed oppose each other.

11. The dyeing method according to claim 10,
wherein the medium to be dyed includes at least one among polyester, acryl, nylon, and a medium having a surface provided with a polyester layer.
